(19) United States
(12) Patent Application Publication
(10) Pub. No.: US 2022/0074665 A1
(43) Pub. Date: Mar. 10, 2022

(54) WALKING BEAM FURNACE FOR CONTINUOUSLY DISCHARGING AND SHREDDING SCALE

(71) Applicant: FIVES STEIN, Maisons Alfort (FR)

(72) Inventor: Michel MATERNOVA, Maisons-Alfort (FR)

(21) Appl. No.: 17/417,886

(22) PCT Filed: Dec. 17, 2019
(86) PCT No.: PCT/FR2019/053126

§ 371 Date: Aug. 5, 2021

(30) Foreign Application Priority Data
Dec. 24, 2018 (FR) 1874133

(51) Int. Cl. F27B 9/20; F27D 25/00

(52) U.S. Cl. CPC F27B 9/201; F27D 25/008

(57) ABSTRACT

Walking beam furnace comprising movable and stationary andirons supported by movable and stationary keels, respectively, and drive means designed to move a lifting frame and a translation frame according to a rectangular displacement cycle having two vertical positions and an intermediate vertical position, the movable andirons being at the same height as the stationary andirons The furnace further comprises stationary and movable beams, the movable beams arranged between the stationary beams and separated from the latter by a space, the movable keels attached to the movable beams, which are attached to the translation frame and arranged at the same height as the stationary refractory beams in the intermediate position. The furnace further comprises a plurality of skirts attached to the other movable beams defining the separation space and dipping into longitudinal water tanks arranged in line with the separation spaces and attached to one of the separation space defining beams.

### TECHNICAL FIELD

The invention relates to reheating furnaces with walking beams intended to heat steel products, for example made of carbon steel or stainless steel, in particular slabs, blooms, blanks or billets, to a temperature suitable for hot rolling thereof.

### PRIOR ART

The furnace allows the products to be heated to high temperatures, around 1150° C. for a carbon steel. The heating of the furnace is commonly carried out by burners operating in a slight excess of air, which results in the presence of oxygen in the furnace. Significant oxidation of the products in the furnace results from the combination of high temperature and the presence of oxygen.

Steel reheating furnaces operate continuously and have significant production capacities, ranging for example from 120 t/h to 650 t/h. The weight loss of the products resulting from the oxidation is commonly on the order of 0.6%. When it comes off the products, scale falls on the hearth of the furnace, where it accumulates.

By the term “scale,” the present description refers not only to the scale per se resulting from the oxidation of the products, but more generally to any solid polluting residue.

The scale can be discharged during periodic shutdowns of the furnace. This solution is not satisfactory because it leads to a significant loss of production due to the time required for cooling the furnace, the manual removal of the scale, then raising the temperature of the furnace. The furnace can be equipped with slag doors from which an operator will debride, that is to say, scrape and mechanically discharge the scale using a tool of the rake type. This solution is not satisfactory either, because the scale located in the center of the furnace is not easy to access. Furthermore, opening these slag doors causes air to enter the furnace, which causes the oxidation of the products present inside to increase.

The walking beam furnace with stationary beams and walking beams is known. The beams comprise cooled andirons and keels. The walking beams allow the transport of the products in the furnace by following a rectangular cycle comprising a first ascent phase which makes it possible to lift the products from the stationary beams. This is followed by a second phase of horizontal transport, then a third phase of depositing the products on the stationary beams. The products are thus moved by one pitch on the stationary beams before the fourth phase of returning the walking beams backward to their initial position. The total duration of a rectangular cycle is approximately 55 seconds.

To limit the black marks caused by the shadow of the andirons on the products, the beams can be offset transversely toward the exit from the furnace, also called the unloading zone.

At the location of the offset of the andirons, at the entrance of the furnace into the product deposit zone and toward the exit from the furnace where the temperature of the products is higher, more scale is formed, which must be removed periodically.

The Applicant has improved the operation of a furnace as presented and has filed patent application EP2516950 for a walking beam reheating furnace which ensures, in a simple and efficient manner, the automatic removal of part of the scale, or other polluting residue, avoiding the aforementioned drawbacks. To this end, it has been proposed that in the areas of the furnace where scale or other polluting residue is mainly produced, in particular toward the entrance and exit of the furnace, the hearth is thicker than in the rest of the furnace, that inclined surfaces be installed in this thicker area of the hearth, with a slant of the walls sufficient to avoid sloping, so as to collect the scale and residues and conduct them toward discharge ducts which open into water tanks, and that the water tanks are attached on the translation frame allowing the continuous discharge of a part of the scale coming from the discharge ducts, while maintaining the sealing of the furnace. The increase in the thickness of the hearth in fact allows an implantation of hoppers formed by inclined surfaces having a significant slant while having a wide opening flush with the hearth in order to cover the maximum possible surface. This feature contributes to discharging scale or other residue.

The Applicant has continued to work on the possibilities of improving such walking beam furnaces.

Indeed, the solution according to the prior art is not entirely satisfactory, because the scale falls mainly on the hearth between the passages for the movable keel, outside the hoppers described above, and this scale is not discharged. Also, the discharge of this majority part of the scale can be carried out only during periodic shutdowns of the furnace, over a period of between six and twelve months.

### DISCLOSURE OF THE INVENTION

One aim of the invention is particularly to remedy all or part of the aforementioned drawbacks.

According to a first aspect of the invention, proposed is a furnace with refractory beams comprising walking beams comprising movable andirons supported by movable keels, and stationary beams comprising stationary andirons supported by stationary keels, and drive means designed to move a lifting frame and a translation frame according to a rectangular displacement cycle having two vertical positions, respectively upper and lower, and an intermediate vertical position according to which the movable andirons are at the same height as the stationary andirons, the movable andirons projecting above the stationary andirons in the upper position, the movable andirons being at a lower level than the stationary andirons in the lower position.

According to the invention, the furnace further comprises:
a plurality of stationary refractory beams extending longitudinally,
a plurality of movable refractory beams extending longitudinally.

The movable refractory beams are arranged transversely between the stationary refractory beams and separated on each side of the stationary refractory beams by a space, the movable keels are attached to the movable refractory beams, and the movable refractory beams are attached to the translation frame and arranged substantially at the same height as the stationary refractory beams in the intermediate position.

The furnace further comprises a plurality of longitudinal water tanks arranged in line with the separation spaces and attached on the stationary refractory beams defining a separation space, and a plurality of skirts attached to the movable refractory beams defining said separation space and dipping into the water tanks.

The stationary refractory beams and the movable refractory beams may extend over all or part of the length of the furnace.

Advantageously, the stationary refractory beams and the movable refractory beams have an inclined and rounded profile on the upper part, the inclined profile possibly having a slant forming, with the horizontal, an angle greater than the slope angle of the scale.

According to one possibility, the stationary refractory beams and the movable refractory beams are made of concrete with a low cement content, based on tabular alumina and spinel.

The furnace may further comprise scrapers attached to the plurality of skirts. The profile of the scrapers can be adapted to promote the crushing and the discharge of the scale. The scrapers can for example have a spade-shaped profile.

The water tank can be equipped with toilet flushes arranged to drive out water, and scale, from unloading to loading.

According to one embodiment, the furnace may comprise refractory beams over only part of the length of the furnace.

At least one water tank may have a rectangular shape, at least one transverse section of the water tank providing a connection between two longitudinal sections of the water tank arranged on either side of a refractory beam.

According to one embodiment, the furnace comprises water tanks equipped with two flushing systems at their end located on the loading side, allowing the discharge of the scale, and a part of the water, in a transverse tank toward a central discharge.

According to a second aspect of the invention, proposed is a method for continuously shredding and discharging scale in a furnace with refractory beams comprising walking beams comprising movable andirons supported by movable keels, and stationary beams comprising stationary andirons supported by stationary keels, and drive means designed to move a lifting frame and a translation frame according to a rectangular displacement cycle having two vertical positions, respectively upper and lower, and an intermediate vertical position according to which the movable andirons are at the same height as the stationary andirons, the movable andirons projecting above the stationary andirons in the upper position, the movable andirons being at a lower level than the stationary andirons in the lower position.

The furnace used in the method for continuously shredding and discharging the scale comprises a plurality of stationary refractory beams extending longitudinally, a plurality of movable refractory beams extending longitudinally, the movable refractory beams being arranged transversely between the stationary refractory beams separated on each side of the stationary refractory beams by a separation space, the movable keels being attached to the movable refractory beams, and the movable refractory beams being attached to the translation frame and arranged substantially at the same height as the refractory beams attached in the intermediate position, the furnace further comprising a plurality of water tanks arranged in line with the separation spaces and attached on one of the refractory beams, and a plurality of skirts, attached on the other refractory beam defining said separation space, dipping into the water tanks, the scale being shredded by the beams as it passes through the separation spaces and being continuously discharged by the plurality of water tanks.

### DESCRIPTION OF THE FIGURES

Other advantages and particularities of the invention will become apparent on reading the detailed description of implementations and embodiments, which are in no way limiting, with reference to the appended drawings, in which:

FIG. 1 is a schematic longitudinal sectional view of a walking beam reheating furnace according to the prior art, with cutaway in the central part,

FIG. 2 is a schematic top view of the interior of the furnace shown in FIG. 1,

FIG. 3 is a schematic longitudinal sectional view of a reheating furnace according to a first embodiment of the invention, with cutaway in the central part,

FIG. 4 is a top view of the interior of the furnace shown in FIG. 3,

FIG. 5 has, in its left part, a half-section along section B-B of FIGS. 3 and 4, and has, in its right part, a half-section along section A-A of FIGS. 1 and 2,

FIG. 6 shows three vertical positions of a movable refractory beam relative to stationary refractory beams according to the invention of the furnace shown in FIG. 3,

FIG. 7 is a schematic longitudinal sectional view of a reheating furnace according to a second embodiment of the invention, with cutaway in the central part,

FIG. 8 is a top view of the interior of the furnace shown in FIG. 7,

FIG. 9 is a detail view on a larger scale of the furnace shown in FIG. 7, with the right side part cut away,

FIG. 10 is a top view of the interior of a furnace according to a third embodiment of the invention,

FIG. 11 is a detail view of a water tank shown in top view in the left part of the drawing and in cross-section in the right part of the drawing, according to a first embodiment of the invention,

FIG. 12 is a detail view of a water tank shown in top view in the left part of the drawing and in cross-section in the right part of the drawing, according to a second embodiment of the invention.

### DESCRIPTION OF EMBODIMENTS

Since the embodiments described hereinafter are not limiting in nature, it is possible in particular to consider variants of the invention that comprise only a selection of the features that are described, provided that this selection of features is sufficient to confer a technical advantage or to differentiate the invention from the prior art. This selection comprises at least one preferably functional feature without structural details, or with only a portion of the structural details if this portion alone is sufficient to confer a technical advantage or to differentiate the invention from the prior art.

In the figures, an element appearing in a plurality of figures retains the same reference.

### DESCRIPTION OF THE PRIOR ART

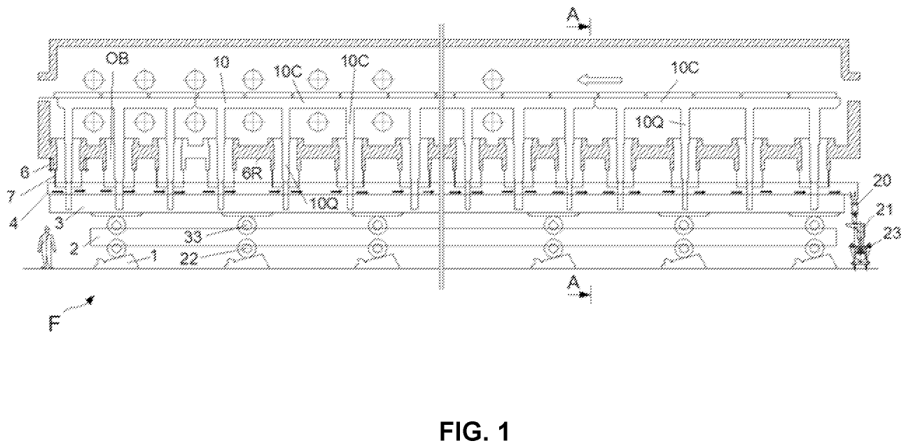

FIG. 1 schematically shows, in side view, a heating furnace F with walking beams 10 according to the prior art. The two end parts of the furnace, on the loading side and the unloading side, are shown, the central part being cut away. As shown by the arrow in FIG. 1 which illustrates the movement direction of the products, the loading side is located to the right of the figure and the unloading side to the left. This is the case for all the figures which show a furnace in side view.

A translation frame 3 rests on upper rollers 33 for translating a lifting frame 2, which in turn rests on ramps 1 having an inclined plane, via lower rollers 22.

A drive means (not shown) according to a horizontal reciprocating movement, parallel to the longitudinal direction of the furnace, is provided for the translation frame 3; another similar drive means (not shown) is provided for the lifting frame 2. These drive means are for example hydraulic cylinders. The combination of the back and forth movements, and the vertical upward and downward movement due to the ramps 1, makes it possible to obtain a rectangular displacement cycle.

The walking beams 10 comprise movable keels 10Q and movable andirons 10C, the andirons being supported by the movable keels which are attached below the translation frame 3.

The movable keels 10Q pass through the stationary hearth 6.

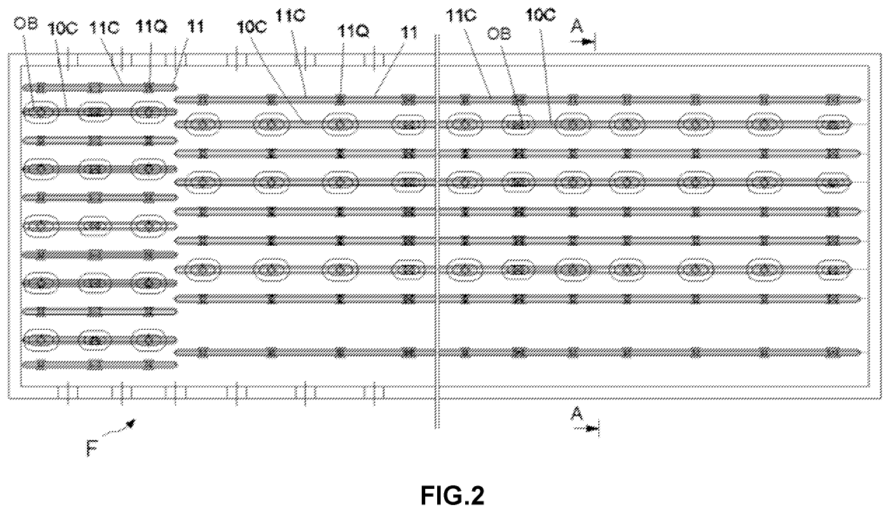

Stationary beams 11 (FIG. 2), comprising stationary keels 11Q mounted on the hearth 6 and stationary andirons 11C, the stationary andirons being carried by the stationary keels, are interposed between the walking beams 10.

The stationary hearth 6 has, on the laboratory side of the furnace, a part lined with refractory materials forming a stationary refractory hearth 6R.

When the hearth passes through the movable keels 10Q, the seal between the hearth 6 and the furnace mechanics is obtained by longitudinal water tanks 4 (FIG. 1) secured to the translation frame 3, passed through by the movable keels 10Q, and skirts 7 secured to the hearth 6 and dipping into the water of the water tanks 4.

Oblong openings OB (FIG. 2), also called buttonholes, are provided in the hearth 6 for the passage and the longitudinal relative movement of the movable keels 10Q. When it is detached from the products, a small amount of scale falls into the oblong openings OB existing in the hearth 6 in line with the passage of the movable keels 10Q and in the bottom of the water tanks 4.

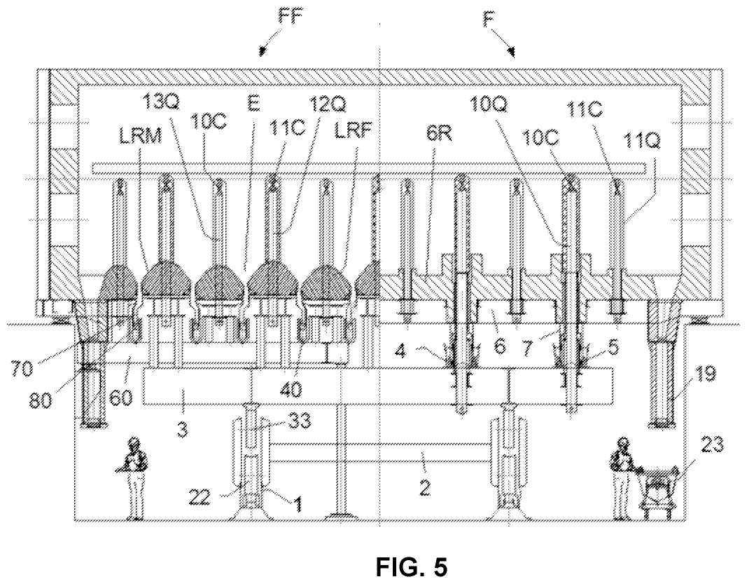

A plurality of scrapers 5 (FIG. 5) is attached to the base of the skirts 7, over the length of the latter, and is thus immersed in the water tanks 4. The scrapers 5 allow the transport of the scale to recovery hoppers (not shown), placed at the end of the water tanks 4, by the relative movement between the water tanks 4 and the scrapers 5, obtained by the association of the stationary position of the scrapers 5 and the rectangular displacement of the water tanks 4.

More precisely, in the high position, with each advance of the water tanks 4 attached on the movable translation frame 3, the scrapers 5 attached on the stationary skirts which open into the water tanks 4 push the quantity of scale located in the bottom of the water tanks 4 with a translational pitch from the furnace exit to the furnace entrance, that is to say, from unloading toward loading, to the ends of the water tanks 4.

The discharge of the scale recovered under the installation is ensured via discharge pipes. The discharge pipes open into, or are connected to, discharge circuits provided with a diaphragm control valve 20 (FIG. 1), acting as a flushing system 20, allowing, upon each opening, the discharge of a quantity of scale and water which falls, through a transverse chute 21, into a wagon on wheels 23.

### DESCRIPTION OF THE INVENTION

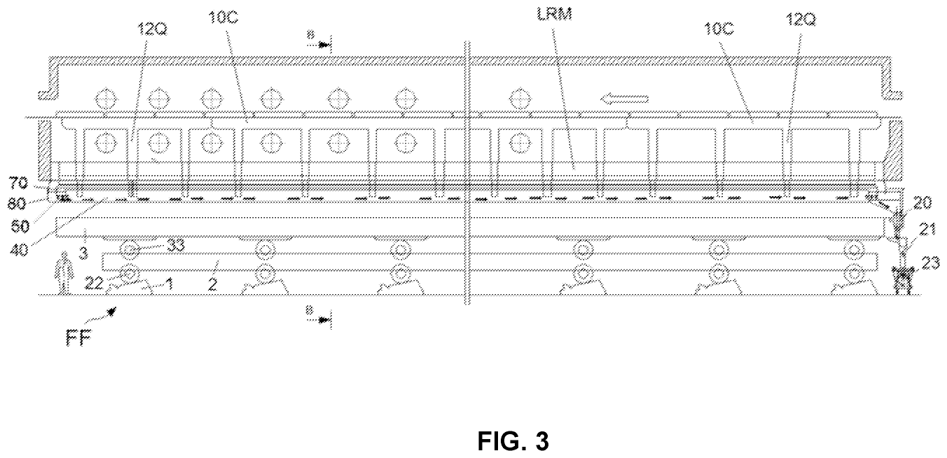

FIG. 3 schematically shows a first embodiment of a furnace FF according to the invention. The two end parts of the furnace, on the loading side and the unloading side, are shown, the central part being cut away.

As in the prior art, the furnace FF comprises the translation frame 3, which rests on the upper translation rollers 33 of the lifting frame 2, which in turn rests on the ramps 1 having an inclined plane, via lower rollers 22.

The drive means of the lifting and translation frames (not shown) are as according to the prior art.

The walking beams 10 are also formed by movable keels 12Q and movable andirons 10C. The movable keels 12Q according to the invention are shorter than the movable keels 10Q according to the prior art. They are supported by a new type of movable refractory beam LRM.

The movable refractory beam LRM is placed and attached on the translation frame 3 over the entire length of the furnace. According to another possibility, the movable refractory beam LRM is placed on the translation frame over only part, or more, of the length of the furnace.

The movable keels 12Q pass through, and are attached on, the movable refractory beam LRM comprising refractory materials which rest on a metal structure.

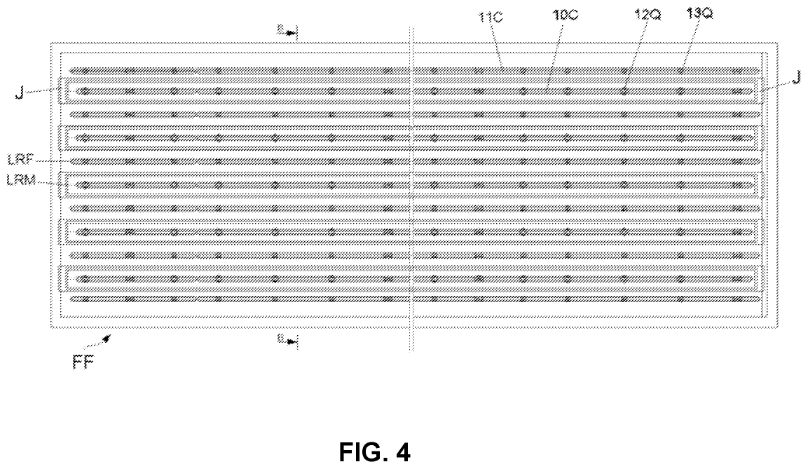

At each end of the furnace, a clearance J (FIG. 4) is provided at each walking beam, so that the longitudinal movement of the walking beam is possible.

Stationary refractory beams LRF of a new type are available.

The stationary refractory beams LRF comprise stationary keels 13Q and stationary andirons 11C, the stationary andirons 11C being carried by the stationary keels 13Q. The stationary refractory beams LRF are interposed between the movable refractory beams LRM.

The refractory materials of which the movable refractory beams LRM and the stationary refractory beams LRF are made are refractory concretes with a high operating temperature and a high resistance to abrasion and impact. They can for example be concretes with a low cement content, based on tabular alumina and spinel. For example, the concrete can contain 92% Al2O3 and 5% MgO.

The refractory materials can be heavy concrete, which has a particularly high density. After drying, this density is for example 3000 kg/m3 (which can even reach up to 6000 km/m3) versus 2000 to 2300 km/m³ for traditional concrete (for comparison, the density of lightweight concrete is between 300 and 2000 kg/m3).

More precisely, the stationary LRF and movable LRM refractory beams comprise a metallic lower part, on the side opposite the laboratory of the furnace, on which the refractory material rests. This metallic lower part is connected to the translation frame for the movable refractory beams and to the fixed hearth for the stationary refractory beams. The stationary and movable keels pass through the refractory material and are attached to the metallic lower parts.

As illustrated in the left part of FIG. 5, the transverse juxtaposition of the movable refractory beams LRM and of the stationary refractory beams LRF according to the invention forms a functional equivalent of the refractory hearth 6R of the furnace according to the prior art shown in the right part of FIG. 5.

A space E is left between the movable refractory beams LRM and the stationary refractory beams LRF, over the entire refractory height. This space E has the function, in a first upper part of conical shape, of guiding the scale toward a discharge passage located in its lower part. There is thus a discharge space for the scale on each side of the stationary refractory beams LRF and of the movable refractory beams LRM, all along the furnace, or along the length equipped with refractory beams LRM and LRF according to the invention.

The up and down movements and front and back translational movements of the movable refractory beams relative to the stationary refractory beams allow the shredding of the scale and facilitate the passage of the scale without blocking an amalgam, or even pieces, of refractory lining.

The distance between the side beams in the lower part of the space E is sufficient for the passage of the scale after shredding. In its lower part, it is for example between 50 and 100 mm.

It is understood that the scale which previously remained on the refractory stationary hearth 6R can now fall through the discharge passages E.

In addition, the stationary LRF and movable LRM refractory beams according to the invention transversely have an inclined and rounded profile on the upper part on which the keels are positioned. The inclined profile is determined with an angle greater than the slope angle, facilitating the shredding and discharging of the scale in the passage E provided for this purpose between the stationary refractory beams and the movable refractory beams LRM. The angle of the inclined profile is for example greater than 45°.

The seal between the hearth, formed by the stationary and movable refractory beams, and the furnace mechanics consisting of the lifting frame and the translation frame, is obtained by longitudinal water tanks 40 (FIGS. 3 and 5) secured to the stationary refractory beams and metallic skirts 70 secured to the movable refractory beams and dipping into the water tanks 40.

The water tanks 40 are attached on each side of the stationary refractory beams LRF.

The skirts 70 are attached to each side of the movable refractory beams LRM.

Furthermore, the profile of the skirts 70 makes it possible to avoid the direct radiation of the environment of the furnace laboratory on the surface of the water contained in the water tanks 40 in order to minimize the heat losses through the openings and the consumption of water.

The water tanks 40 are no longer passed through by the movable keels 10Q.

The length of the movable keels is reduced compared to that according to the prior art, on the order of one meter and fifty centimeters.

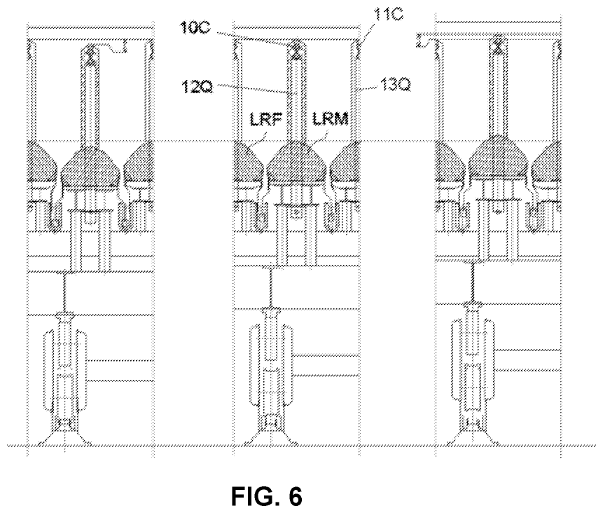

As can be seen in FIG. 6, the movable refractory beams can have three vertical positions with respect to the stationary refractory beams, respectively low (on the left side of the figure), intermediate (in the center of the figure), and high (on the right side of the figure).

In addition, the keel passage according to the prior art was surrounded by fibrous fibers which, when torn off, led to oxidation. This is no longer the case with the solution according to the invention, in which the keel 12Q is embedded in the refractory of the movable refractory beam LRM. Bottom keel lining solutions had been sought, for example by means of stainless steel sheets, but the latter heated, deformed and did not hold.

According to the example shown in this embodiment, the movable skirts 70 are equipped with a plurality of scrapers 50 attached to the metallic skirts 70. The scrapers 50 dip into the water tanks 40 and allow the transport of the scale to recovery hoppers (not shown), placed at the end of the tanks, by the relative movement between the water tanks and the scrapers obtained by the association of the rectangular displacement of the scrapers 50 and the stationary position of the water tanks 40.

More precisely, the translation frame 3 being in the high position, upon each advance of the walking beams LRM, the metallic scrapers 50 push the quantity of scale found in the bottom of the water tanks 40 between two scrapers with a translation pitch toward the end of the water tanks 40.

The scrapers help to crush the scale, which facilitates its discharge into the water tank 40. The scrapers thus have a profile adapted to promote crushing and the discharge of the scale, for example in the shape of a spade.

The end of the water tank 40 is equipped with a diaphragm control valve 20 (FIG. 3), acting as a flushing system 20, which discharges the scale through the chutes 21 into the wagons on wheels 23, the discharge being done in the direction from the exit of the furnace toward the entrance of the furnace.

According to a first variant of this first embodiment, described only for its differences with respect to the first embodiment, the skirts 70 are not equipped with scrapers.

The scale can be driven from the water tanks 40 onto which it falls by a device external to the furnace, for example by hoses of the fire hose type.

According to a second variant of this first embodiment, the water tanks 40 can be provided with nozzles (80) for spraying water (FIG. 3), arranged at the unloading area, which push the scale toward the end of the water tank 40 located on the loading side.

The water tanks 40 can be provided with water injection 80, for example with spray nozzles, which, under pressure, drives the scale toward the flushing systems 20.

According to this variant, it is possible not to equip the skirts 70 with scrapers.

Of course, the skirts 70 can still be equipped with scrapers to improve the crushing of the scale.

According to a third variant of this first embodiment, described only for its differences with the first embodiment and possibly combinable with the first variant, two or three intermediate discharge points for the scale can be provided.

For this purpose, it is proposed to have, at each of these discharge points, a transverse tank provided with ducts receiving the scale coming from the water tanks 40. On each side of the transverse tank, the tank is equipped with flushing systems that push the scale toward the center of the transverse tank, which has other ducts fitted with diaphragm control valves.

Each of the transverse tanks can advantageously be placed between two wheels 33.

This second variant is particularly advantageous in the context of a very long furnace.

The water tanks can also be attached to the movable refractory beams LRM. In this case, it is necessary to take into account the wave effect at the end of the water tank generated by the displacement of the beams.

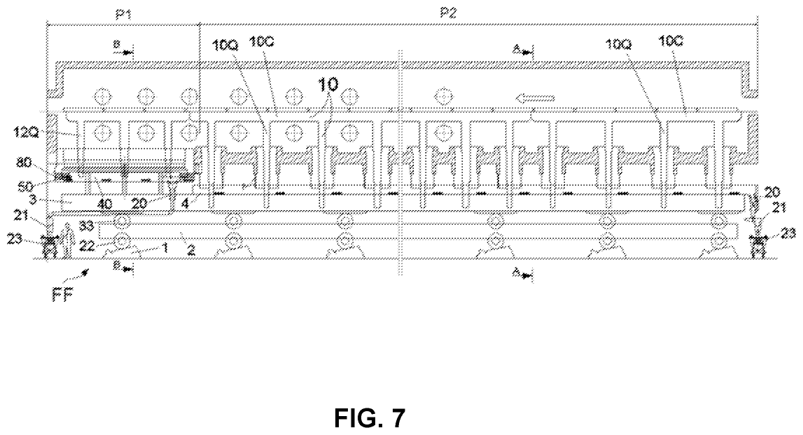

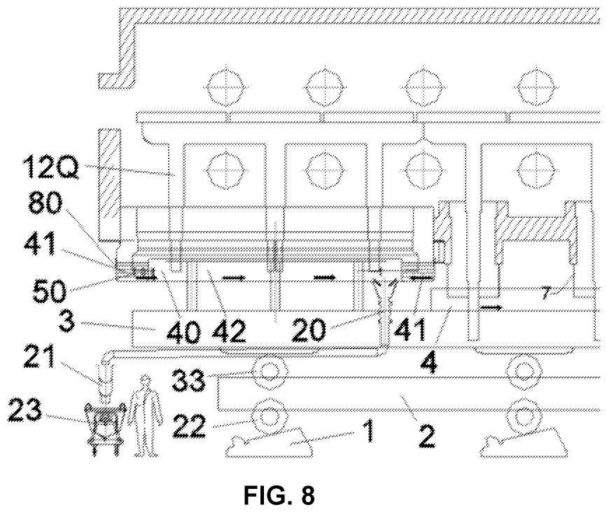

FIGS. 7 to 9 schematically show a second embodiment of a furnace FFF according to the invention.

The furnace FFF is described only for its differences with the first embodiment, and could adopt the features of one or more of the variants of the first embodiment.

As can be seen in FIG. 7, on the loading side, the furnace has a longitudinal part P2 similar to that described according to the prior art, from loading to a longitudinal position from which a part PI begins which is similar to that as described with reference to the first embodiment of the invention.

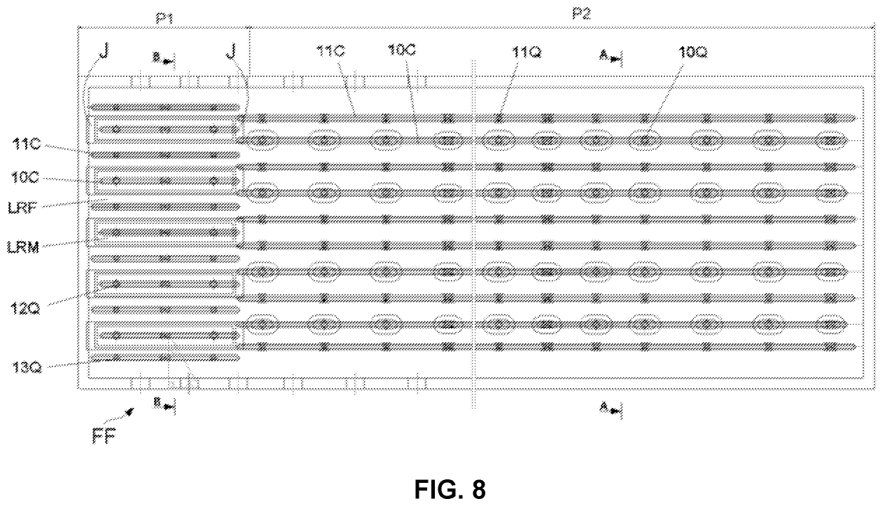

It should be noted that, to limit the black marks caused by the shadow of the andirons on the products, the refractory beams can also be offset transversely toward the exit of the furnace, as can be seen in FIG. 8.

In this embodiment, the furnace comprising refractory beams LRF, LRM over only part of its length, at least one water tank 40 has a rectangular shape or is U-shaped, at least one transverse section 41 of the water tank ensuring a connection between two longitudinal sections 42 of the water tank arranged on either side of a stationary refractory beam.

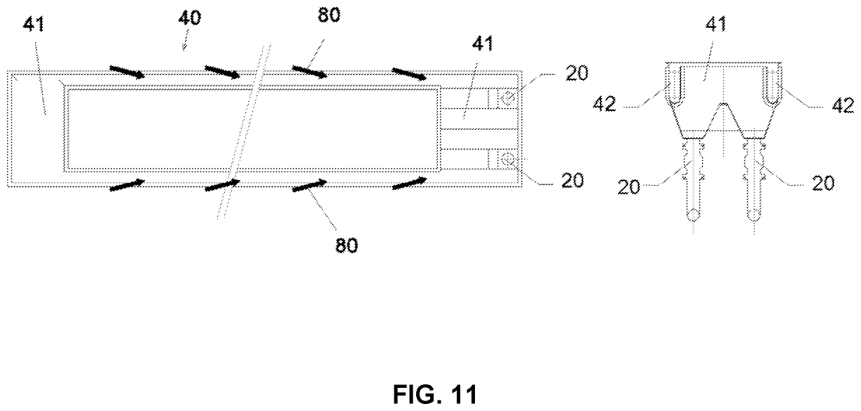

FIG. 11 illustrates an embodiment of a water tank 40 according to the invention, in the case shown in FIGS. 3 and 4 where the water tank runs the entire length of the furnace, with a top view of the water tank in the left part of the figure and a cross-sectional view thereof in the right part of the figure. The rectangular water tank comprises two longitudinal parts 42 arranged on either side of a stationary refractory beam, not shown, and two transverse connections 41 between these longitudinal parts arranged on either side of the refractory beam, at each end of the longitudinal parts. To ensure the sealing of the furnace, skirts 70, not shown, dip into the water tank along the longitudinal parts 42 and the transverse connections 41, thus ensuring continuity of the hydraulic seal. It is also noted that the water tank is provided with two flushing systems 20, located on the transverse connection 41 located on the loading side of the furnace, one for each longitudinal part of the water tank, and water spray nozzles 80 represented by arrows.

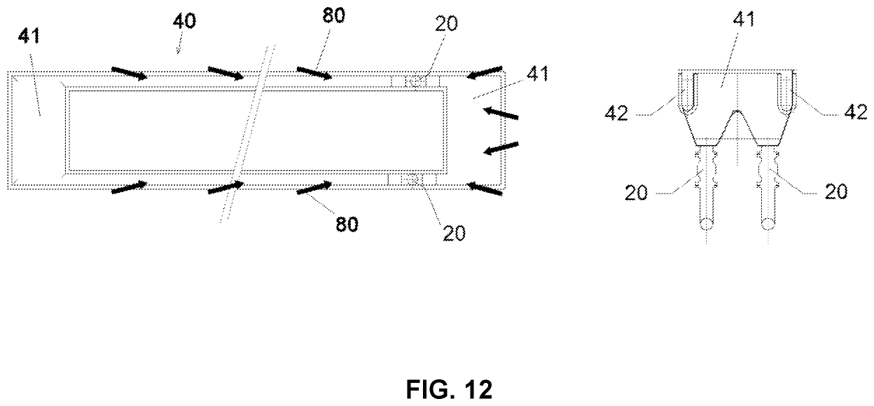

FIG. 12 illustrates another embodiment of a water tank 40 according to the invention, in the case shown in FIGS. 7 and 8 where the refractory beams according to the invention are only on a part of the furnace, in this case during unloading, with a top view of the water tank in the left part of the figure and a cross-sectional view thereof in the right part of the figure. The rectangular-shaped water tank also comprises two longitudinal parts 42 arranged on either side of a stationary refractory beam, not shown, and two transverse connections 41 between these longitudinal parts arranged on either side of the refractory beam, at each end of the longitudinal parts. Note that in this embodiment, the water tank is provided with a flushing system 20 arranged on each longitudinal part of the water tank, and water spray nozzles 80 represented by arrows.

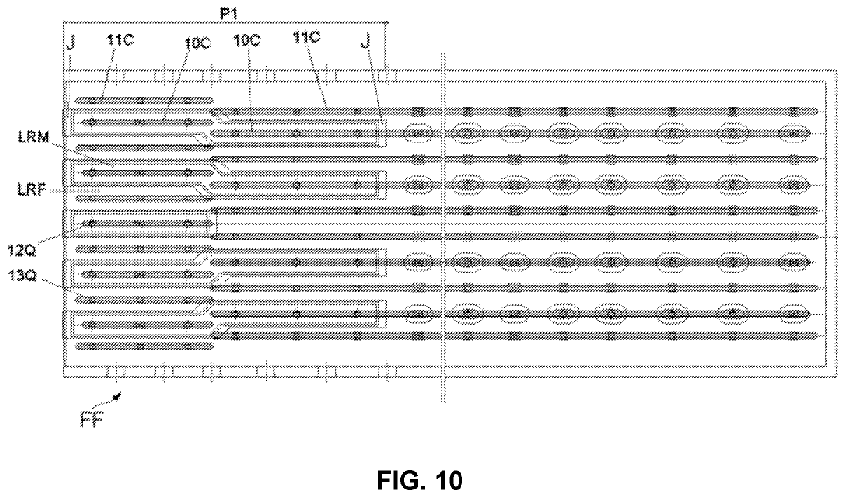

FIG. 10 illustrates a variant of the embodiment shown in FIG. 8 in which the transverse offset of the beams to limit the black marks caused by the shadow of the andirons on the products is carried out on the part PI of the furnace, in this example about mid-length relative thereto.

As will be readily understood, the invention is not limited to the examples that have just been described, and numerous modifications can be made to these examples without departing from the scope of the invention. In addition, the various features, forms, variants, and embodiments of the invention can be grouped together in various combinations as long as they are not incompatible or mutually exclusive.

TABLE 1

| E | discharge duct |
|---|---|
| F | reheating furnace according to the prior art |
| FF | reheating furnace according to a first embodiment of the invention |
| FFF | reheating furnace according to a second embodiment of the |
| | invention |
| OB | oblong opening |
| FRM | movable refractory beam |
| FRF | stationary refractory beam |
| 1 | lifting ramp with an inclined plane |
| 2 | lifting frame |
| 3 | translation frame |
| 4 | water tank |
| 5 | scraper |
| 6 | stationary metallic hearth |
| 6R | refractory stationary hearth |
| 7 | skirt |
| 10 | walking beam according to the prior art |
| 10C | movable andiron |
| 10Q | movable keel according to the prior art |
| 12Q | movable keel according to the invention |
| 11 | stationary beam according to the prior art |
| 11C | stationary andiron |
| 11Q | stationary keel according to the prior art |
| 13Q | stationary keel according to the invention |
| 19 | vertical chute |
| 20 | diaphragm control valve |
| 21 | transverse chute located along a wall for recovering scale falling in |
| | this area. |
| 22 | lower translation rollers |
| 23 | wagon on wheels |
| 33 | upper lifting rollers |
| 40 | water tank |
| 41 | transverse connection of a water tank |
| 42 | longitudinal section of a water tank |
| 50 | scrapers |
| 70 | skirts |
| 80 | water spray nozzle in a water tank |

1. A walking beam furnace comprising:
a plurality of stationary refractory beams extending longitudinally and a plurality of movable refractory beams extending longitudinally, the movable refractory beams being arranged transversely between the stationary refractory beams and separated on either side of the stationary refractory beams by a space, drive means arranged to move a lifting frame and a translation frame, supporting the movable refractory beams, according to a rectangular displacement cycle having two vertical positions, upper and lower, respectively, and an intermediate vertical position according to which the walking beams are at the same height as the stationary beams, the walking beams projecting above the stationary beams in the upper position, the walking beams being at a lower level than the stationary beams in the lower position, the furnace further comprising a plurality of longitudinal water tanks arranged in line with the separation spaces and attached to one of the refractory beams defining a separation space, and a plurality of skirts attached to the other refractory beam defining said separation space and dipping into the water tanks,
wherein the stationary refractory beams and the movable stationary refractory beams have an inclined and rounded profile on the upper part, the inclined profile having a slant forming, with the horizontal, an angle greater than the slope angle of the scale.

2. The furnace according to claim 1, wherein the stationary refractory beams and the movable stationary refractory beams extend over all or part of the length of the furnace.

3. The furnace according to claim 1, wherein the stationary refractory beams and the movable refractory beams are made of concrete with a low cement content, based on tabular alumina and spinel.

4. The furnace according to claim 1, further comprising scrapers, the profile of which is adapted to promote the crushing and discharging of the scale, attached on the plurality of skirts.

5. The furnace according to claim 4, wherein the scrapers have a suitable spade-shaped profile.

6. The furnace according to claim 1, wherein the water tank is provided with water spray nozzles and flushing systems arranged to drive out the water and the scale from the water tank.

7. The furnace according to claim 1, comprising refractory beams over only part of the length of the furnace, characterized in that at least one water tank has a rectangular shape or is U-shaped, at least one transverse connection of the water tank ensuring a connection between two longitudinal sections of the water tank arranged on either side of a refractory beam.

8. A method for continuously shredding and discharging scale in a walking beam furnace comprising:
a plurality of stationary refractory beams extending longitudinally and a plurality of movable refractory beams extending longitudinally, the movable refractory beams being arranged transversely between the stationary refractory beams and separated on either side of the stationary refractory beams by a space, drive means arranged to move a lifting frame and a translation frame, supporting the movable refractory beams, according to a rectangular displacement cycle having two vertical positions, upper and lower, respectively, and an intermediate vertical position according to which the walking beams are at the same height as the stationary beams, the walking beams projecting above the stationary beams in the upper position, the walking beams being at a lower level than the stationary beams in the lower position, the furnace further comprising a plurality of longitudinal water tanks arranged in line with the separation spaces and attached to one of the refractory beams defining a separation space, and a plurality of skirts attached to the other refractory beam defining said separation space and dipping into the water tanks,
wherein the stationary refractory beams and the movable stationary refractory beams having an inclined and rounded profile on the upper part, the inclined profile having a slant forming, with the horizontal, an angle greater than the slope angle of the scale, the scale being shredded by the beams as it passes through the separation spaces and being continuously discharged by the plurality of water tanks.

9. The method according to claim 8, further comprising a step of crushing and discharging the scale by means of scrapers with a suitable profile attached to the plurality of skirts.
